(19) United States
(12) Patent Application Publication
(10) Pub. No.: US 2008/0158520 A1
(43) Pub. Date: Jul. 3, 2008

(54) LIGHT TUNNEL

(75) Inventor: PI-TSUNG HSU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/761,169

(22) Filed: Jun. 11, 2007

(30) Foreign Application Priority Data
Dec. 27, 2006 (CN) 200610201420.1

(51) Int. Cl. G03B 21/28

(52) U.S. Cl. 353/84; 353/99

(57) ABSTRACT

An exemplary light tunnel includes at least three reflectors arranged one adjoining the other in sequence, thereby forming a corresponding at least three-sided enclosed conduit structure. At each of a plurality of junctions where a first adjoining reflector and a second adjoining reflector adjoin each other, an end portion of the first adjoining reflector abuts an end face of the second adjoining reflector and extends beyond an outer surface of the second adjoining reflector. The two adjoining reflectors are joined to each other by adhesive. The adhesive extends between a extending part of the end portion of the first adjoining reflectors that extends beyond the outer surface of the second adjoining reflector and a part of the outer surface of the second adjoining reflector.

### TECHNICAL FIELD

The present invention relates to projection systems and, particularly, to a light tunnel that can applied to various projection systems with various light sources and image generation devices.

### BACKGROUND

In recent years, projection systems have been widely applied to presentation and entertainment. Conventional projection systems are generally classified into DLP (Digital Light Processing) projection systems and LCD (Liquid Crystal Display) projection systems. The DLP projection systems use digital micromirror devices (DMD) as the image generation devices thereof. The DLP projection systems use LCDs as the image generation devices thereof.

Referring to FIG. 12, a typical DLP projection system includes a light source 10, a color wheel 12, a light tunnel 13, a relay lens 14, a DMD 15, and a projection lens 16. The light source 10 emits light, which is reflected and focused onto the color wheel 12 by a reflector 11. The light passes through the light tunnel 13 and the relay lens 14 and then reaches the DMD 15 obliquely. After being processed with the DMD 15, the light goes to the projection lens 16 and subsequently is projected onto a screen 17 for generating desired images.

The light tunnel 13 is typically used to guide the light (e.g., to change/orient the progressing direction of the light) and to collimate the light. In addition, the light tunnel 13 can improve the luminance uniformity and control the aspect ratio of the projected light. The light tunnel 13 is also known as a light rod, an integration rod, a light pipe, or a rod lens. The light tunnel 13 can, e.g., be a solid rod or a hollow rod.

Referring to FIG. 13, a typical hollow light tunnel 20 includes a first pair of reflectors 21, a second pair of reflectors 22, and four adhesive portions 25. The two pairs of reflectors 21 and 22 have uniform thicknesses. Each reflector has a reflective inner surface and two side surfaces extending along a longitudinal direction thereof. Halves of the two side surfaces of each reflector 21 contact and adjoin between the two reflective inner surfaces of the second pair of reflectors 22. Each adhesive portion 25 adheres between adjacent exposed side surfaces of the reflectors 21 and 22.

However, on the one hand, in the light tunnel 20, each adhesive portion 25 has a small area (e.g., half the area of each side surface) adhering to each side surface of the reflectors 21 and 22. This relatively small adherence area typically results in an insufficient adhering strength between two adjacent reflectors 21 and 22. On the other hand, each side surface of the two reflectors 21 has a small area (e.g., half the area of each side surface) contacting the reflective inner surfaces of the two reflectors 22. Thus, it is prone to suffer from both adhesive leakage and light leakage from the small contact area. As a result, the above light tunnel 20 tends to have a short operating lifetime and an inherent efficiency in maximizing the available light.

FIG. 14 illustrates another typical hollow light tunnel 30. The light tunnel 30 includes four reflectors 31 and four adhesive portions 33. The four reflectors 31 have uniform thicknesses. Each reflector 31 has a reflective inner surface and two side surfaces extending along a longitudinal direction thereof. Each adhesive portion 33 adheres between one side surface and one adjacent reflective inner surface. However, it is also prone to suffer from adhesive leakage along each reflective inner surface, thereby impairing the reflective properties of each reflective inner surface.

What is needed, therefore, is a light tunnel that has relatively high quality of adherence and light transmission and that has a relatively long operating lifetime.

What is needed, also, is a projection system incorporating such an improved light tunnel.

### SUMMARY

In accordance with a preferred embodiment, a light tunnel includes at least three reflectors arranged with one adjoining the other, in sequence, thereby correspondingly forming an at least three-sided enclosed conduit structure. At each of a plurality of junctions where a first adjoining reflector and a second adjoining reflector adjoin each other, an end portion of the first adjoining reflector abuts an end face of the second adjoining reflector and extends beyond an outer surface of the second adjoining reflector. The two adjoining reflectors are joined to each other by adhesive. The adhesive extends between an extending part of the end portion of the first adjoining reflectors that extends beyond the outer surface of the second adjoining reflector and a part of the outer surface of the second adjoining reflector.

A projection system includes a light source, a light tunnel, a relay lens, an image generation device, and a projection lens. The light source is configured for generating light. The relay lens is configured for receiving and converging the light from the light tunnel. The image generation device is configured for receiving the light from the relay lens and generating an image. The projection lens is configured for projecting the image onto a screen. The light tunnel includes at least three reflectors arranged one adjoining the other, in sequence, thereby correspondingly forming an at least three-sided enclosed conduit structure. At each of a plurality of junctions where a first adjoining reflector and a second adjoining reflector adjoin each other, an end portion of the first adjoining reflector abuts an end face of the second adjoining reflector and extends beyond an outer surface of the second adjoining reflector. The two adjoining reflectors are joined to each other by adhesive. The adhesive extends between an extending part of the end portion of the first adjoining reflectors that extends beyond the outer surface of the second adjoining reflector and a part of the outer surface of the second adjoining reflector.

Other advantages and novel features will be drawn from the following detailed description of preferred embodiments when considered in conjunction with the attached drawings.

### BRIEF DESCRIPTION OF THE DRAWINGS

Many aspects of the present light tunnel and projection system can be better understood with reference to the following drawings. The components in the drawings are not necessarily drawn to scale, the emphasis instead being placed upon clearly illustrating the principles of the present light tunnel and projection system. Moreover, in the drawings, like reference numerals designate corresponding parts throughout the several views.

FIG. 1 is a schematic, isometric view of a light tunnel, according to a first preferred embodiment;

FIG. 2 is a schematic, cross-sectional view along line II-II in FIG. 1;

FIG. 3 is a schematic, isometric view of a light tunnel, according to a second preferred embodiment;

FIG. 4 is a schematic, cross-sectional view taken along line IV-IV in FIG. 3;

FIG. 5 is a schematic, isometric view of a light tunnel, according to a third preferred embodiment;

FIG. 6 is a schematic, cross-sectional view taken along line VI-VI in FIG. 5;

FIG. 7 is a schematic, isometric view of a light tunnel, according to a fourth preferred embodiment;

FIG. 8 is a schematic, cross-sectional view taken along line VIII-VIII in FIG. 7;

FIG. 9 is a schematic, isometric view of a light tunnel, according to a fifth preferred embodiment;

FIG. 10 is a schematic, cross-sectional view taken along line X-X in FIG. 9;

FIG. 11 is a schematic view of a projection system having any light tunnel of FIG. 1 through FIG. 10;

FIG. 12 is a schematic view a conventional projection system;

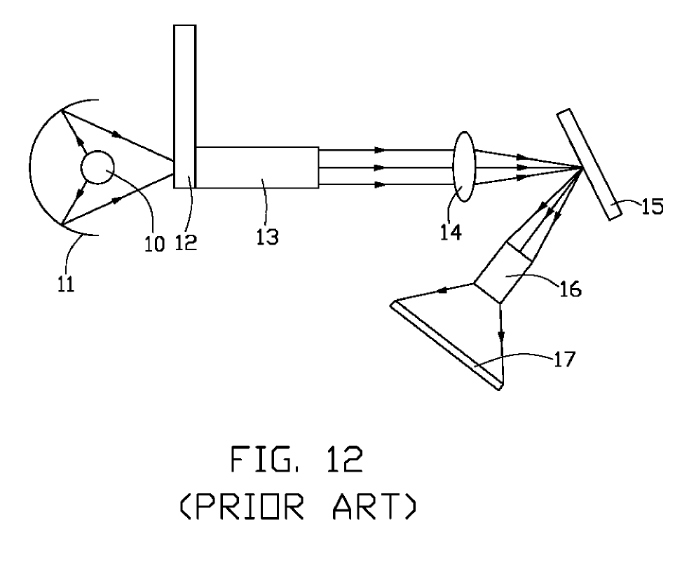

FIG. 13 is a schematic, cross-sectional view of a conventional light tunnel; and

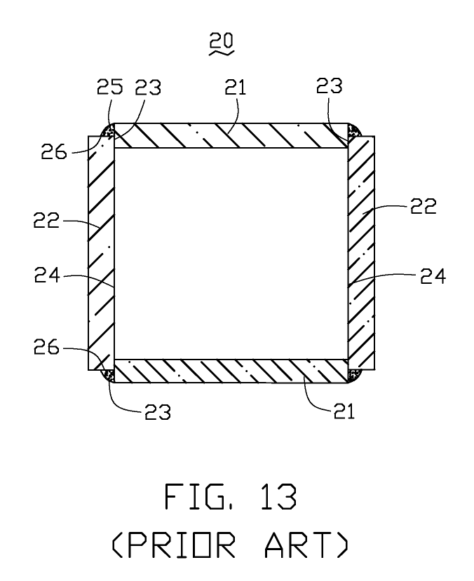

FIG. 14 is a schematic, cross-sectional view of another conventional light tunnel.

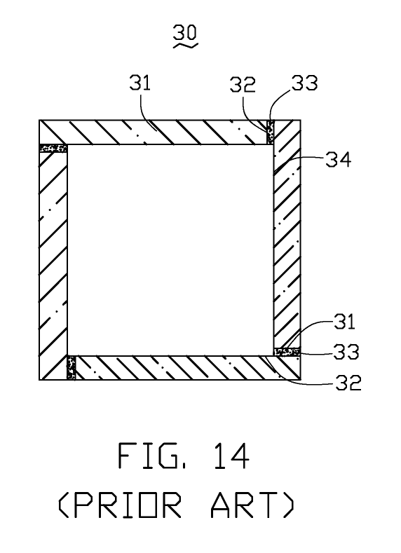

### DETAILED DESCRIPTION OF THE PREFERRED EMBODIMENT

Embodiments of the present light tunnel and projection system will now be described in detail below and with reference to the drawings.

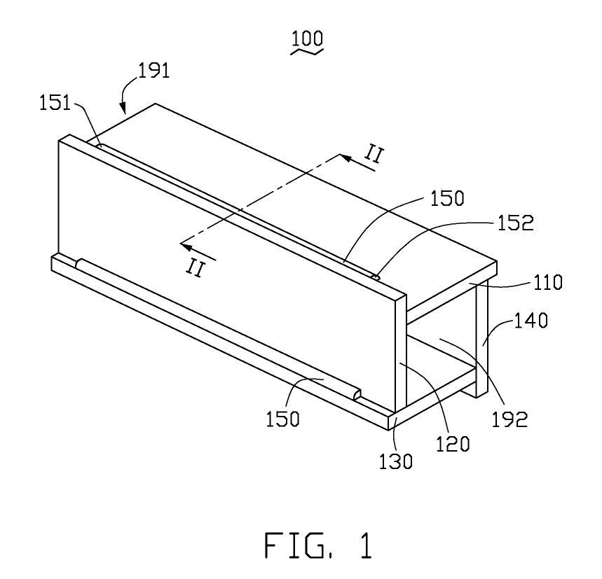

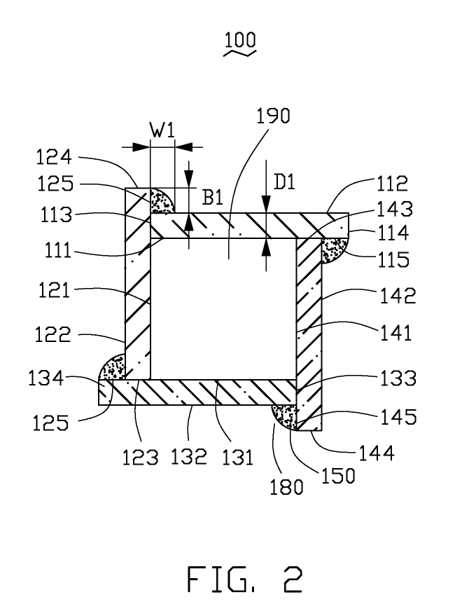

FIGS. 1 and 2 illustrate a light tunnel 100, in accordance with a first preferred embodiment. The light tunnel 100 includes a first reflector 110, a second reflector 120, a third reflector 130, a fourth reflector 140, and four adhesive portions 150. Each of the four adhesive portions 150 is configured (i.e., structured and arranged) for bonding a respective two adjacent reflectors, for example, the first and the second reflectors 110, 120. The four reflectors 110, 120, 130, 140 cooperatively define a light guiding conduit 190. The light guiding conduit 190 has a light entrance 191 and a light exit 192 at two opposing ends thereof. For the purposes of the present light tunnel, the term “conduit” may include the volume through which light is capable of traveling and/or the boundary element(s) that thereby defines such a volume.

The four reflectors 110, 120, 130, 140 have essentially a similar structure. Each of the four reflectors 110, 120, 130, 140 is advantageously cuboid in form, e.g., a flat glass sheet. The four reflectors 110, 120, 130, 140 advantageously have uniform thicknesses D1. The first, second, third, fourth reflectors 110, 120, 130, 140, respectively, have reflective inner surfaces 111, 121, 131, 141, outer surfaces 112, 122, 132, 142, contact end faces 113, 123, 133, 143, and exposed end faces 114, 124, 134, 144.

The contact end faces 113, 123, 133 and 143 of the first, second, third, fourth reflectors 110, 120, 130 and 140, respectively, face towards and contact with the reflective inner surface 121, 131, 141 and 111 of the second, third, fourth, first reflectors 120, 130, 140 and 110. The reflective inner surface 111, 121, 131 and 141 of the first, second, third, fourth reflectors 110, 120, 130 and 140, respectively, have end portions 115, 125, 135 and 145. The end portions 115, 125, 135 and 145, respectively, protrude out of (i.e., extend beyond) the outer surface 142, 112, 122 and 132 of the fourth, first, second, third reflectors 140, 110, 120 and 130. The end portions 115, 125, 135 and 145, respectively, abut the contact end faces 143, 113, 123, 133. Each end portion is advantageously a rectangular region extending along a longitudinal direction of one respective reflector. Each of the end portions 115, 125, 135, and 145 and one respective outer surface (i.e., 142, 112, 122, and 132) cooperatively define an outer junction 180, where two adjacent reflectors adjoin each other. The outer junction 180 faces away from the light guiding conduit 190. Each of the four end portions 115, 125, 135, and 145 have a protrusion height more than the thickness D1 of each of the four reflector 110, 120, 130, and 140. Thus, the four outer junctions 180 can provide enough space to receive desired volume of adhesive therein.

The four adhesive portions 150 are, respectively, disposed at the four outer junctions 180, so as to bond adjacent reflectors 110, 120, 130, or 140 together. Each adhesive portion 150 extends between one respective end portion and a part of one respective outer surface of two adjacent reflectors, for example, between the end portion 145 of the fourth reflector 140 and a part of the outer surface 132 of the third reflector 130. Preferably, each adhesive portion 150 adheres to a face of one respective end portion that is adjacent to the respective outer surface. The four adhesive portions 150 may cover all or part of the faces of the four end portions. A distance of each part of the faces beyond the outer surface of one adjacent reflector is advantageously the same as or greater than a thickness of the adjacent reflector. Each adhesive layer 150 has a bonding thickness B1, corresponding to the respective end portions 115, 125, 135, or 145. Likewise, each adhesive layer 150 has another bonding thickness W1, corresponding to the respective outer surfaces 112, 122, 132, and 142. The two bonding thicknesses B1 and W1 are advantageously thicker than the thicknesses D1 of the four reflectors 110, 120, 130, and 140. The four adhesive portions 150 have larger bonding areas, corresponding to the reflective inner surface 111, 121, 131, 141 and the outer surface 112, 122, 132, 142, than the surface area of the contact end faces 113, 123, 133, and 143 of the four reflectors 110, 120, 130, 140. Thus, the four adhesive portions 150 can provide enough bonding force between two adjacent reflectors to adequately maintaining such joining long-term. An area of the adhesive portions 150 at the parts of the outer surface is, advantageously, the same as or greater than an area of the adhesive portions 150 at the face of the end portion.

Each outer junction 180 runs along a longitudinal direction of one corresponding reflector. Thus, the four adhesive portions 150 run along the longitudinal direction of the corresponding reflector. Preferably, each of the four adhesive portions 150, respectively, has two extending ends 151 and 152 at a distance relative to two ends of the respective reflector, thereby preventing the light entrance 191 and the light exit 192 from being contaminated by over-extended adhesive. The distance is advantageously in the range from about 0.1 millimeter to about 15 millimeters. Thus, each adhesive layer 150 is shorter by about 0.2 millimeters to about 30 millimeters than the respective reflectors 110, 120, 130, or 140. The four adhesive portions 150 could, usefully, be an ultraviolet curable gel.

Preferably, four reflective layers are coated on the four reflective inner surfaces 111, 121, 131 and 141, respectively. The four reflective layers could, advantageously, be metal films having high reflectivity, for example, aluminum films or silver films. Alternatively or additionally, the four reflectors 110, 120, 130, 140 could be made of a highly reflective material, for example, aluminum, diamond, or silver.

During operation, light enters into the light guiding conduit 190 via the light entrance 191 thereof. The incident light is reflected by the four reflective inner surfaces 111, 121, 131, and 141 and thus guided along the light guiding conduit 190. The four reflectors 110, 120, 130, 140 are firmly and effectively bonded together via the four adhesive portions 150. Each contact end face of the four reflectors entirely contacts the respective reflective inner surface of adjacent reflectors, accordingly usefully decreasing the risks of adhesive leakage and light leakage. Thus, the light is reflected in a suitably uniform fashion and exits from the light exit 192. Therefore, the light tunnel 100 has relatively high quality of durability (i.e., the probable failure point typically presented at the bonding regions, with improved bonding thus having a direct impact on durability) and light transmission and can operate effectively for a relatively long period.

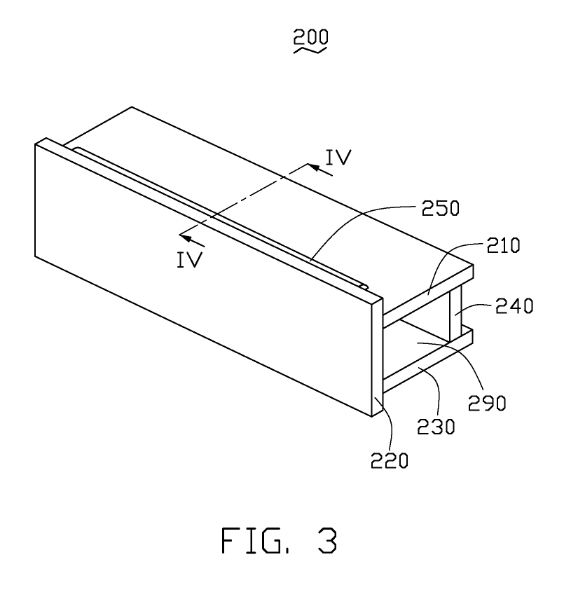

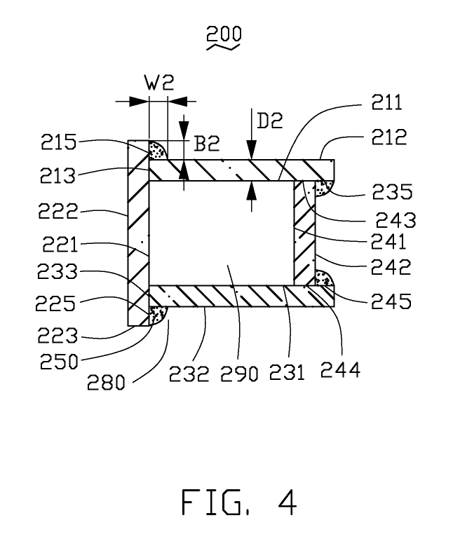

FIGS. 3 and 4 illustrate a light tunnel 200, in accordance with a second preferred embodiment. The light tunnel 200 includes a first reflector 210, a second reflector 220, a third reflector 230, a fourth reflector 240, and four adhesive portions 250. Each of the four adhesive portions 250 is configured for bonding two adjacent reflectors, for example, the first and the second reflectors 210, 220.

The four reflectors 210, 220, 230, 240 and the four adhesive portions 250 are essentially similar to the four reflectors 110, 120, 130, 140 and the four adhesive portions 150, respectively, except with respect to contact surfaces between the four reflectors 210, 220, 230, 240 and bonding positions of the four adhesive portions 250.

The four reflectors 210, 220, 230, 240, respectively, have reflective inner surfaces 211, 221, 231, 241 and outer surfaces 212, 222, 232, 242. The first and third reflectors 210, 230, respectively, have contact end faces 213, 233 tightly contacting and facing toward the reflective inner surface 221 of the second reflector 220. The fourth reflector 240 has two contact end faces 243, 244, respectively, tightly contacting and facing toward the reflective inner surfaces 211, 231 of the first and third reflector 210, 230. Each reflective inner surface adjoins two adjacent reflective inner surfaces, thereby cooperatively defining a light guiding conduit 290 therein.

The reflective inner surface 221 of the second reflector 220 has two end portions 215, 225. The two end portions 215, 225, respectively, protrude out of (i.e., extend beyond) the outer surfaces 212, 232 of the first and third reflectors 210, 230. The reflective inner surfaces 211, 231 of the first and third reflectors 210, 230, respectively, have end portions 235, 245. The two end portions 235, 245 protrude out of (i.e., extend beyond) the outer surface 242 of the fourth reflectors 240.

Each of the four end portions 215, 225, 235 and 245 is beneficially a rectangular region extending along a longitudinal direction of one respective reflector. The four end portions 215, 225, 235, and 245 advantageously have uniform protrusion heights equal to or more of the thicknesses of the respective reflectors. Each of the four end portions 215, 225, 235 and 245 and one adjacent outer surface (i.e., 212, 222, 232, 242) cooperatively define an outer junction 280. The four outer junctions 280 are essentially similar to the corresponding outer junctions 180.

Each outer junction 280 elongates/extends along a longitudinal direction of a corresponding reflector. The four adhesive portions 250 are disposed at the four outer junctions 280, respectively. The four adhesive portions 250 are essentially similar to the four adhesive portions 150. For example, each adhesive portion 250 extends between one respective end portion and a part of one respective outer surface of two adjacent reflectors. Thus, each adhesive layer 250 has a bonding thickness B2 corresponding to the respective end portions 215, 225, 235, or 245. Likewise, each adhesive layer 250 has another bonding thickness W2, corresponding to the respective outer surfaces 212, 232 or end portions of the outer surface 242. The two bonding thicknesses B2 and W2 are advantageously wider than thicknesses D2 of the four reflectors 110, 120, 130, and 140.

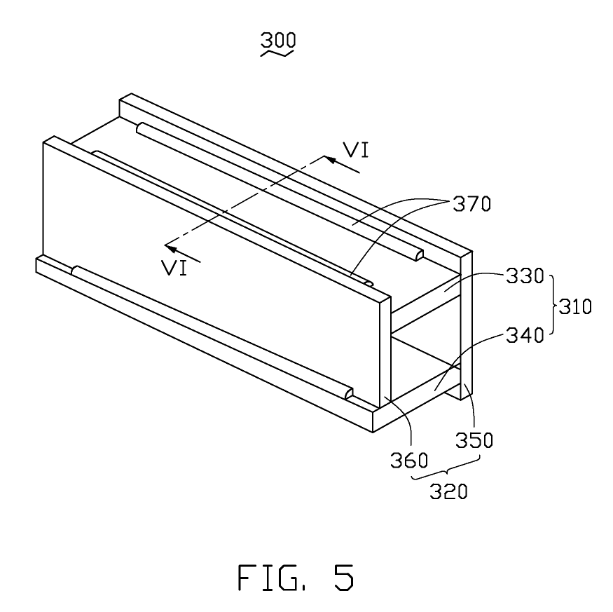

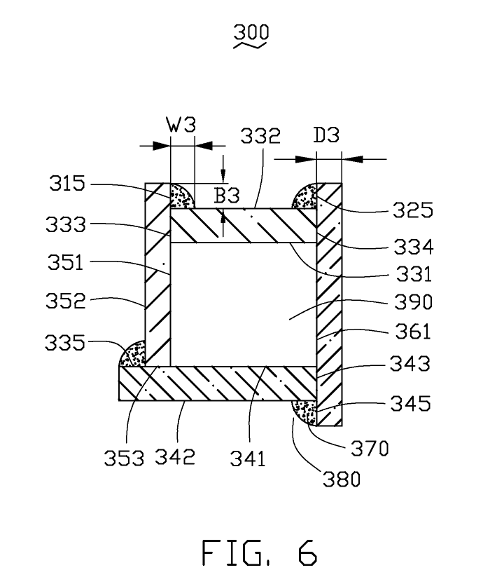

FIGS. 5 and 6 illustrate a light tunnel 300, in accordance with a third preferred embodiment. The light tunnel 300 includes a first reflector group 310, a second reflector group 320, and four adhesive portions 370. The first reflector group 310 includes a first reflector 330 and a second reflector 340 substantially parallel to the first reflector 330. The second reflector group 320 includes a third reflector 350 and a fourth reflector 360 substantially parallel to the third reflector 350. The four adhesive portions 370 are configured for bonding two adjacent reflectors, for example, the first and the third reflectors 330, 350.

The four reflectors 330, 340, 350, 360 are essentially similar to the four reflectors 110, 120, 130, 140, respectively, except with respect to thicknesses thereof and contact end faces therebetween.

The first and second reflectors 330, 340, advantageously, have uniform thicknesses. The third and fourth reflectors 350, 360 could, suitably, have uniform thicknesses D3 and/or be thinner than the first and second reflectors 330, 340. Alternatively, the first and second reflectors 330, 340 could have different thicknesses. The third and fourth reflectors 350, 360 could, likewise, have different thicknesses.

The four reflectors 330, 340, 350, 360, respectively, have reflective inner surfaces 331, 341, 351, 361 and outer surfaces 332, 342, 352, 362. The first reflector 330 has contact end faces 333, 334, respectively, tightly contacting and facing toward the reflective inner surfaces 351, 361 of the third and fourth reflectors 350, 360. The second reflector 340 has a contact end face 343, tightly contacting and facing toward the reflective inner surface 361 of the fourth reflector 360. The third reflector 350 has a contact end face 353, tightly contacting and facing toward the reflective inner surface 341 of the second reflector 340. Each reflective inner surface adjoins two adjacent reflective inner surfaces, thereby cooperatively defining a light guiding conduit 390 therein.

The four adhesive portions 370 are essentially similar to the four adhesive portions 150, except with respect to the bonding positions and thicknesses thereof. The inner reflective surface 341, 351 of the second and third reflectors 340, 350 have end portions 315, 335, respectively, protruding out of (i.e., extending beyond) the outer surface 332, 352 of the corresponding first and third reflectors 330, 350. The inner reflective surface 361 of the fourth reflector 360 has two end portions 325, 345, respectively, protruding out of (i.e., extending beyond) the corresponding outer surface 332, 342 of the first and second reflector 330, 340.

The four end portions 315, 325, 335 and 345 are essentially similar to the four end portions 215, 225, 235 and 245, except with respect to thicknesses thereof. The four end portions 215, 225, 235 and 245 advantageously have uniform protrusion heights equal to or exceeding the thicknesses D3 of the third and fourth reflectors 350, 360. Each of the four end portions 315, 325, 335 and 345 and a corresponding one adjacent outer surface (i.e., 332, 332, 352, 342) cooperatively define a respective outer junction 380. Each outer junction 380 is essentially similar to a given outer junction 180 or 280.

Each respective adhesive layer 370 is applied at one respective outer junction 380. Each adhesive layer 370 has a first bonding thickness B3 corresponding to adjacent outer surface (e.g., 332) and a second bonding thickness W3 corresponding to an adjacent end portion (e.g., 315). The two bonding thicknesses B3 and W3 of each adhesive layer 370 are advantageously more than the thicknesses D3 of a given one of the third and fourth reflectors 350, 360. Alternatively, the two bonding thicknesses B3 and W3 of the adhesive portions 370 could equal or exceed the respective thickness of a given one of the first and second reflectors 330, 340.

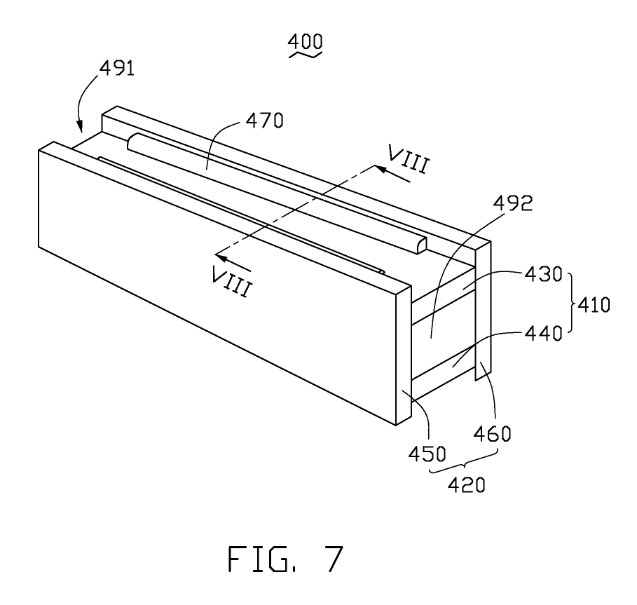

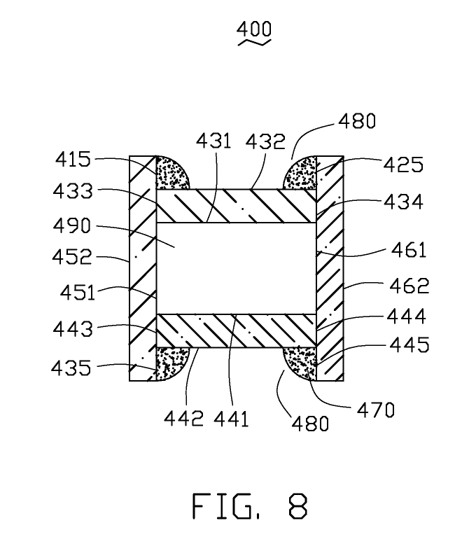

FIGS. 7 and 8 illustrate a light tunnel 400, in accordance with a fourth preferred embodiment. The light tunnel 400 includes a first reflector group 410, a second reflector group 420, and four adhesive portions 470. The first reflector group 410 includes a first reflector 430 and a second reflector 440 substantially parallel to the first reflector 430. The second reflector group 420 includes a third reflector 450 and a fourth reflector 460 substantially parallel to the third reflector 450. Each of the first and second reflectors 430, 440 is respectively interposed between a corresponding one of the third and fourth reflectors 450, 460. The four adhesive portions 470 are configured for bonding two adjacent reflectors, for example, 430 and 450.

The four reflectors 430, 440, 450 and 460 advantageously have a trapezoid cross-section along longitudinal directions thereof and a rectangle cross-section along latitudinal directions thereof (i.e., along line IV-IV). The four reflectors 430, 440, 450, 460 advantageously have respective thicknesses substantially equal to those of the four reflectors 330, 340, 350, 360, respectively.

The four reflectors 430, 440, 450, 460 have reflective inner surfaces 431, 441, 451, 461 and outer surfaces 432, 442, 452, 462, respectively. The first reflector 430 has two contact end faces 433, 434, respectively, tightly contacting and facing toward the reflective inner surfaces 451, 461 of the third and fourth reflectors 450, 460. The second reflector 440 has two contact end faces 443, 444, respectively, tightly contacting and facing toward the reflective inner surfaces 451, 461 of the third and fourth reflectors 450, 460. Each reflective inner surface respectively adjoins two adjacent reflective inner surfaces, thereby cooperatively defining a light guiding conduit 490 therein. The light guiding conduit 490 is advantageously a tapered volume. Interior of the boundaries thereof, the volume may comprise a void/open zone. Distances between the first and second reflectors 330, 340 and distances between the third and fourth reflectors 350, 360 are tapered between a light exit 492 and a light entrance 491 of the light guiding conduit 490 in either a gradual/sloping or step manner.

The reflective inner surfaces 451 has two end portions 415, 435, respectively, protruding out of (i.e., extending beyond) the outer surface 432, 442 of the first and second reflector 430, 440. Likewise, the reflective inner surfaces 461 have two end portions 425, 445, respectively, protruding out of (i.e., extending beyond) the outer surface 432, 442 of the first and second reflector 430, 440. The four end portions 415, 425, 435, 445 are essentially similar to the four end portions 315, 325, 335, 345. The four end portions 415, 425, 435, 445 and the two outer surfaces 432, 442 cooperatively define four outer junctions 480. The four outer junctions 480 are essentially the same as the four outer junctions 380.

The four adhesive portions 470 are disposed at the four outer junctions 480, respectively. The four adhesive portions 470 have dimensions substantially equal to or exceeding the corresponding dimensions of the four adhesive portions 370.

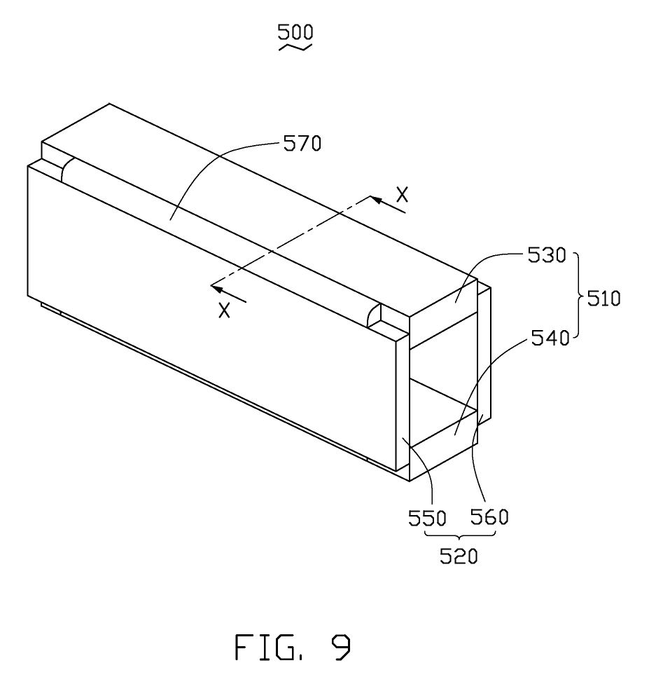

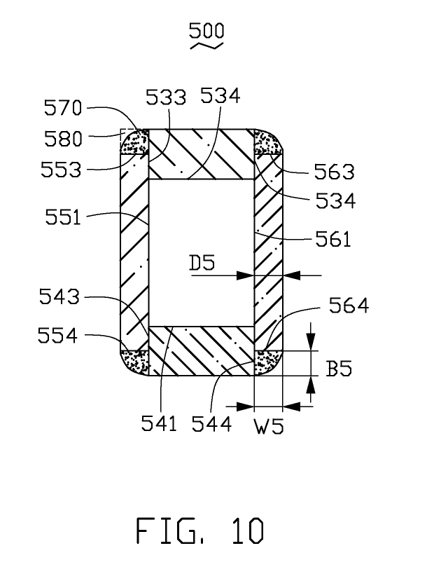

FIGS. 9 and 10 illustrate a light tunnel 500, in accordance with a fifth preferred embodiment. The light tunnel 500 includes a first reflector group 510, a second reflector group 520, and four adhesive portions 570. The first reflector group 510 includes a first reflector 530 and a second reflector 540 essentially parallel to the first reflector 530. The second reflector group 520 includes a third reflector 550 and a fourth reflector 560 parallel to the third reflector 550. Each of the first and second reflectors 530, 540 is interposed between the third and fourth reflectors 550, 560. Each of the four adhesive portions 570 is configured for bonding two respective adjacent reflectors, for example, 530 and 550.

The four reflectors 530, 540, 550, 560 are essentially similar to the four reflectors 330, 340, 350, 360, except with respect to the thicknesses and contact end faces thereof. The first and second reflectors 530, 540 advantageously have uniform thicknesses. The third and fourth reflectors 550, 560 usefully have a uniform thickness D5. The first and second reflectors 530, 540 respectively have double or more the thickness of the corresponding third and fourth reflectors 550, 560. Alternatively, the first and second reflectors 530, 540 could have different thicknesses. The third and fourth reflectors 550, 560 could have different uniform thicknesses.

The four reflectors 530, 540, 550, 560 have reflective inner surfaces 531, 541, 551, 561, respectively. The first reflector 530 has two contact end faces 533, 534, respectively, partially and tightly contacting and facing toward the respective reflective inner surfaces 551, 561 of the third and fourth reflectors 550, 560. The second reflector 540 has two contact end faces 543, 544, respectively, partially and tightly contacting and facing toward the reflective inner surfaces 551, 561 of the third and fourth reflectors 550, 560. Each respective reflective inner surface adjoins two adjacent reflective inner surfaces, accordingly cooperatively defining a light guiding conduit 590 thereby. The light guiding conduit 590 could, advantageously, be a cuboid volume, through which the guided light may travel.

The third reflector 550 has two end faces 553 and 554 respectively perpendicular to the two contact end faces 533 and 543 of the first and second reflectors 530, 540. The fourth reflector 560 has two end faces 563 and 564 respectively perpendicular to the two contact end faces 533 and 543 of the first and second reflectors 530, 540. Preferably, a contact part of each contact end face (e.g., 533, 534, 543, or 544) respectively abuts and contacts one respective reflective inner surface (e.g., 551 or 561). A remaining part of each contact end face (e.g., 533, 534, 543, or 544) respectively is located beyond adjacent end faces (e.g., 553, 563, 554, or 564). Accordingly, each contact end face 533, 534, 543, or 544 and corresponding adjacent end face 553, 554, 563, or 564 cooperatively define an outer junction 580.

Each of the four adhesive portions 570 is disposed at one respective outer junction 580. Thus, each of the four adhesive portions 570 extends between the remaining part of each contact end face and the end face of two adjacent reflectors, for example, between the remaining part of contact end face 533 of the first reflector 530 and the end face 553 of the third reflector 550. An area of the adhesive at the remaining part of each end face of the thicker reflector (e.g., 530 or 540) is the same as or greater than an area of the adhesive at each end face of the thinner reflector (e.g., 550 or 560). A portion of the remaining part of each contact face is advantageously covered with adhesive. Each adhesive layer 570 has two bonding thicknesses B5 and W5 corresponding to adjacent contact end face (e.g., 544) and end face (e.g., 564), respectively. The two bonding thicknesses B5 and W5 are advantageously uniform and are more than the thicknesses D5 of the third and fourth reflectors 550 and 560. Therefore, the four reflectors 530, 540, 550, 560 can be firmly and effectively bonded together via the four adhesive portions 570.

Additionally, the first and second reflectors 530, 540 have contact thicknesses corresponding to reflective inner surface 551, 561. The contact thicknesses are equal to or more than the thicknesses D5 of the third and fourth reflectors 550 and 560, accordingly usefully decreasing the risks of adhesive leakage and light leakage.

Furthermore, it is to be understood that the light tunnel could be modified or varied by those skilled in the art in order to satisfy various applications. Each component of the present light tunnel could be changed and substituted by each other among the above embodiments. For example, the first reflector 530 of the fifth light tunnel 500 could have the same thickness corresponding to the third and fourth reflectors 550, 560. The same to the first reflector 430, the first reflector 530 could be interposed between the third and fourth reflectors 550, 560.

Moreover, it is to be noted that although four reflectors are exemplarily illustrated herein, three or more than four reflectors may be optionally selected in the application of the present light tunnel by those skilled in the art and be within the scope thereof. For example, when using three reflectors, the light tunnel would be a hollow three-sided enclosed conduit structure. Likewise, when using five or more reflectors, the light tunnel would be a five-sided or multi-sided enclosed conduit structure.

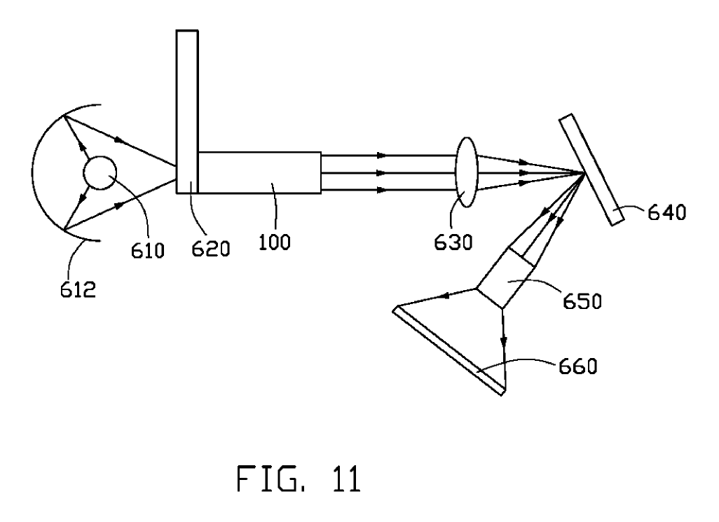

FIG. 11 illustrates a projection system 600 incorporating any light tunnel (i.e., 100, 200, 300, 400 or 500) of above embodiments. In addition to the light tunnel, the projection system 600 includes a light source 610, a color wheel 620, a relay lens 630, an image generation device 640, and a projection lens 650. The light source is configured for generating light. The light source could, e.g., be a high-intensity discharge (HID) lamp and/or a light emitting diode (LED) lamp. A reflection sheet 612 is advantageously disposed around a side of the light source 610, the reflection sheet 612 being configured for reflecting and converging the light onto the color sheet 620. The color wheel 620 is disposed facing toward the light source. The color wheel 620 is configured for receiving the light generated from the light source 610 and splitting light. Then, the light is thereby directed to enter the present light tunnel, where the light is homogenized and collimated. The relay lens 630 is disposed adjacent the light tunnel and is optically aligned with the light tunnel. The relay lens 630 is configured for converging light onto the image generation device 640. As the light is directed out via the projection lens 650, an image can be projected and shown on a projection lens 660.

The image generation device 640 could be a DMD or liquid crystal display (LCD). The DMD includes a plurality of micro mirrors configured for reflecting light into the projection lens 650, via a light digital processing (LDP) technology. When using the LCD, the projection system 600 does not require the color wheel 620.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A light tunnel comprising:
at least three reflectors respectively arranged one adjoining another in sequence, thereby forming a corresponding at least three-sided enclosed conduit structure;
wherein at each of a plurality of junctions where a first adjoining reflector and a second adjoining reflector adjoin each other, an end portion of the first adjoining reflector abuts an end face of the second adjoining reflector and extends beyond an outer surface of the second adjoining reflector, and the two adjoining reflectors are joined to each other by adhesive, the adhesive extending between an extending part of the end portion of the first adjoining reflector that extends beyond the outer surface of the second adjoining reflector and a part of the outer surface of the second adjoining reflector.

2. The light tunnel as claimed in claim 1, wherein a distance that the extending part extends beyond the outer surface of the second adjoining reflector is the same as or greater than a thickness of the second adjoining reflector.

3. The light tunnel as claimed in claim 2, wherein the adhesive extends between a face of the extending part that is adjacent to the end face of the second adjoining reflector and the part of the outer surface of the second adjoining reflector.

4. The light tunnel as claimed in claim 3, wherein the adhesive extends between all of the face of the extending part and the part of the outer surface of the second adjoining reflector.

5. The light tunnel as claimed in claim 3, wherein an area of the adhesive at the face of the extending part is the same as or greater than an area of the adhesive at the face of the extending part, and the reflective inner surface of the second adjoining reflector extends out of the outer surface of the first adjoining reflector, the outer junction being thereby defined between the reflective inner surface of the second adjoining reflector and the outer surface of the first adjoining reflector.

6. The light tunnel as claimed in claim 2, wherein the at least three reflectors comprises four reflectors, the four reflectors comprising a first reflector group and a second reflector group, each respective reflector group comprising two reflectors parallel to each other, each reflector of the first reflector group adjoining one respective reflector of the second reflector group, a thickness of each reflector of the first reflector group being greater than a thickness of each reflector of the second reflector group.

7. The light tunnel as claimed in claim 6, wherein the distance that the extending part extends beyond the outer surface of the first reflector group is the same as or greater than a thickness of each reflector of the second reflector group.

8. The light tunnel as claimed in claim 1, wherein the two adjoining reflectors have different thickness from each other.

9. The light tunnel as claimed in claim 1, wherein each reflector has a reflective inner surface coated with a reflective layer.

10. The light tunnel as claimed in claim 1, wherein the conduit structure defines a tapered volume therein.

11. A light tunnel comprising:
at least three reflectors arranged one adjoining another in sequence, thereby forming a corresponding an at least three-sided enclosed conduit structure;
wherein each two adjacent reflectors have thicknesses different from each other, a contact part of an end face of a thicker one of the two reflectors abuts an inner surface of the thinner one of the two reflectors, a remaining part of the end face of the thicker reflector is located beyond an end face of the thinner reflector, an area of the remaining part of the end face of the thicker reflector is substantially equal to an area of the end face of the thinner reflector, and the respective two adjoining reflectors are joined to each other by adhesive, the adhesive extending between the remaining part of the end face of the thicker reflector and the end face of the thinner reflector.

12. The light tunnel as claimed in claim 11, wherein the adhesive extends between a part of the remaining part of the end face of the thicker reflector and all of the end face of the thinner reflector.

13. The light tunnel as claimed in claim 12, wherein an area of the adhesive at the remaining part of the end face of the thicker reflector is the same as or greater than an area of the adhesive at the end face of the thinner reflector.

14. The light tunnel as claimed in claim 13, wherein the area of the adhesive at the end face of the thinner reflector is the same as or greater than an area of the contact part of the end face of the thicker reflector.

15. A projection system comprising:
a light source configured for generating light;
a light tunnel disposed facing toward the light source, the light tunnel comprising:
at least three reflectors arranged one adjoining the other in sequence thereby forming a corresponding at least three-sided enclosed conduit structure;
wherein at each of a plurality of junctions where a first adjoining reflector and a second adjoining reflector adjoin each other, an end portion of the first adjoining reflector abuts an end face of the second adjoining reflector and extends beyond an outer surface of the second adjoining reflector, and the two adjoining reflectors are joined to each other by adhesive, the adhesive extending between an extending part of the end portion of the first adjoining reflector that extends beyond the outer surface of the second adjoining reflector and a part of the outer surface of the second adjoining reflector;
a relay lens configured for receiving and converging the light from the light tunnel;
an image generation device configured for receiving the light from the relay lens and generating an image; and
a projection lens configured for projecting the image to a screen.

16. The projection system as claimed in claim 15, wherein the image generation device is one of a digital micro-mirror device and a liquid crystal display.

17. The projection system as claimed in claim 15, wherein the image generation device is digital micro-mirror device, the projection system further comprising a color wheel interposed between the light source and the light tunnel, the color wheel being configured for receiving and splitting the light generated from the light source.

18. The projection system as claimed in claim 17, wherein the image generation device is digital micro-mirror device, the projection system further comprising a color wheel interposed between the light source and the light tunnel, the color wheel being configured for receiving and splitting the light generated from the light source.
